(19) United States
(12) Patent Application Publication
(10) Pub. No.: US 2010/0239737 A1
(43) Pub. Date: Sep. 23, 2010

(54) DIETARY FIBER-CONTAINING COMPOSITION FOR BREAD-MAKING, BREAD AND METHOD OF PRODUCTION THEREOF

(75) Inventors: Nobuyoshi Asayama, Itami-shi (JP); Kimihito Wada, Itami-shi (JP)

Correspondence Address: SUGHRUE MION, PLLC, 2100 PENNSYLVANIA AVENUE, N.W., SUITE 800, WASHINGTON, DC, 20037, US

(73) Assignee: Matsutani Chemical Industry Co., Ltd., Itami-shi (JP)

(21) Appl. No.: 12/725,995

(22) Filed: Mar. 17, 2010

(30) Foreign Application Priority Data
Mar. 18, 2009 (JP) 2009-066343

(51) Int. Cl. A21D 10/00; A21D 13/00

(52) U.S. Cl. 426/549; 426/504

(57) ABSTRACT

There is provided a water-soluble dietary fiber-containing composition for bread-making, comprising a homogeneous mixture of a water-soluble dietary fiber material, and an fats and oils, wherein the water-soluble dietary fiber material comprises not less than 85% by mass of a dietary fiber, wherein the water-soluble dietary fiber-containing composition for bread-making comprises 20 to 100 parts by mass of the fats and oils relative to 100 parts by mass of the water-soluble dietary fiber material is provided. Also, there is provided a bread fortified with a water-soluble dietary fiber, produced by using this composition; and a method for producing the bread fortified with a water-soluble dietary fiber comprising adding this composition in a kneading step in a bread-making process.

### TECHNICAL FIELD

The present invention relates to a dietary fiber-containing composition for bread-making to fortify bread with dietary fiber; a bread fortified with the dietary fiber produced by using the dietary fiber-containing composition; and a method for producing the bread.

### BACKGROUND ART

Recently, due to increase of health consciousness, a number of various food products using functional food materials have developed and put on the market. One of those food materials includes dietary fiber. The dietary fiber has a variety of useful physiological actions and is a relatively inexpensive material. Thus, it has recently drawn most attention and has been used as a functional food product.

There are water-soluble dietary fiber materials and non-water soluble dietary fiber materials. Examples of the non-water soluble dietary fiber materials include cellulose, wheat bran, apple fiber, sweet potato fiber and chitin. Examples of the water soluble dietary fiber materials are further roughly divided into high viscous materials and low viscous materials. Examples of the high viscous materials include pectin, powdered konjac (mannan), alginate, propylene glycol alginate, guar gum, and agar. Examples of the low viscous materials include indigestible dextrin, polydextrose, branched maltodextrin, inulin and guar gum decomposition products. These materials have various physiological actions including reduction of cholesterol, prevention of elevation of blood glucose level, regulation of intestinal functions, prevention of colon cancer and excretion of toxic substances.

Also, oligosaccharides are exemplified as one type of the dietary fiber materials. Oligosaccharides are water soluble, low viscous saccharides and have various functions such as cariostatic actions, low calorie, regulating intestine activity and actions to grow bifidobacteria. Representative examples thereof include fructooligosaccharide, galactooligosaccharide and xylooligosaccharide.

As described above, in recent years, a number of food products to which functions are added using dietary fiber materials have been put on the market. Even when the food product has special functions such as physiological functions, it should taste good as an individual food product. And, elements constituting the food product such as outer appearance, textures or tastes are all required to be satisfactory.

Among the dietary fiber materials, water-soluble and low viscous ones (indigestible dextrin, polydextrose and branched maltodextrin) and oligosaccharides are generally materials readily used in the food products. They can be added to water-soluble food products such as beverages, soups and yogurts at a required amount without significant problem.

However, as to food products in a solid form such as a bakery food product, when the added amount of the dietary fiber material is increased, problems arise in that ease of handling is decreased or the quality of product including texture is deteriorated. For instance, when indigestible dextrin is added to bread, as long as the amount is not more than 4 parts by mass based on the amount of wheat flour, it can be used without affecting the ease of handling and the quality of product. When it is added in an amount of not less than 10% by mass based on the amount of the wheat flour as Foods for Specified Health Uses with the intention of preventing an elevation of blood glucose level or regulating intestinal functions, it has been confirmed that, due to the high water solubility of the indigestible dextrin, formation of gluten is inhibited; molding of dough is blocked; ease of handling is deteriorated; and the quality of product is deteriorated due to chewy and tacky textures or such.

Among the dietary fibers, in the case of water-soluble and highly viscous ones (thickening polysaccharide such as alginic acid or agar), when they are used in bread-making, problems arise in that an increase in the added amount causes a hard texture and deteriorates the quality of product. Because of this, they are merely added in a small amount for the purpose of improving the quality of product and ease of handling.

In order to solve these problems, particularly for water-soluble dietary fibers, various improvement strategies to add a large amount of water-soluble dietary fibers into bakery food products or noodles have been proposed. JP 4-51840 A proposes a method for the production of the bakery products, wherein the indigestible dextrin, water-soluble dietary fiber, is added in the dough mixing of the sponge method in the kneading process. However, the method was not satisfactory because suitability for bread-making (ease of handling in production), tastes, textures, interior crumb and outer appearance were not improved.

JP 10-243777 A proposes a production method of noodles, bakery food products and snack foods to which a water-soluble dietary fiber material and modified starch are added. It could not be said that the method was satisfactory in terms of suitability for kneading (ease of handling in production), tastes and textures.

JP 2001-45960 A proposes a production method of bread fortified with dietary fiber in which dietary fiber materials containing indigestible dextrin and fine cellulose are used as the main raw materials. The method was not satisfactory because the problems in textures were not improved. Also, the cost was high and thus was problematic.

JP 2006-254901 A discloses a composition obtained by mixing a water-soluble dietary fiber and thickening polysaccharide, and drying the mixture. The textures of bakery food products produced using the composition were not necessarily satisfactory.

JP 8-289715 A discloses a baked food product in which dietary fiber coated with fats and oils is dispersed in wheat flour dough and a production method thereof. This method is to obtain a baked food product having a high dietary fiber content as well as retaining crispiness, by kneading in advance fats and oils and a dietary fiber followed by adding wheat flour and auxiliary materials to prepare a dough. However, this baked food product is intended for cookie, biscuit and cracker which hardly involve or do not at all involve dough leavening. JP 8-289715 A does not disclose effects of this method on dough preparation, leavening, and quality of product, when this method is applied to the production of bread based on dough leavening by yeast.

That is, in the preparation of dough in the baked food products such as cookie or biscuit, in order to inhibit formation of gluten structures and to render crispiness, components other than wheat flour, such as fats and oils, are kneaded in advance, and the wheat flour is lastly added, the mixture was roughly uniformly mixed, thereby preparing dough. That is, if the dietary fiber coated with the fats and oils and the components other than the wheat flour are kneaded in advance and then the wheat four is added, problems do not arise.

However, in the preparation of dough for bread wherein dough leavening is carried out by yeast, it is a conventional method that, in order to promote the formation of gluten structures, components other than the fats and oils such as wheat flour are kneaded in advance to form the gluten structures and then the fats and oils are added. In general, the fats and oils, which inhibit the formation of the gluten structures, and wheat flour are not directly kneaded. Therefore, in cases where dietary fiber coated with the fats and oils is kneaded with the wheat flour, a possibility of inhibiting the formation of the gluten structures in the dough cannot be ruled out.

JP 2001-95489 A discloses an oil-in-water type emulsified fats and oils composition for kneading a dough for starch food product containing fats and oils, a dextrin and an emulsifier. This composition is for the purpose of the prevention of retrogradation. In cases where this is used in the production of bread in a range where the quality of product is not affected, the dietary fiber content is very small.

### SUMMARY OF THE INVENTION

### Problems to be Solved by the Invention

An object of the present invention is to solve problems brought about when the above-mentioned water-soluble dietary fiber material is excessively added. That is, the present invention is to provide a water-soluble dietary fiber-containing composition enabling a sufficient amount of dietary fiber to be readily contained such that physiological functions such as prevention of elevation of blood glucose level, regulation of intestinal functions, improvement of lipid metabolism and the like are imparted, and that enabling bread having excellent quality to be readily produced; bread fortified with water-soluble dietary fiber using the composition; and a production method thereof.

### Means for Solving the Problems

To solve the above-mentioned problems, the present inventors have found that, when a water-soluble dietary fiber-containing composition obtained by mixing a water-soluble dietary fiber material with fats and oils used for bread-making at a certain ratio is added to a production process of bread dough as a whole or as a part of the fats and oils, direct kneading with wheat flour does not cause inhibition of formation of gluten structures by fats and oils; and, even if the amount of the composition to be added as the water-soluble dietary fiber is excessive, the preparation of dough is not adversely affected and the quality of product including outer appearance, interior crumb and textures is excellent, thereby achieving the present invention. That is, the present invention provides, as shown below, a dietary fiber-containing composition useful for making bread fortified with water-soluble dietary fiber; bread fortified with the water-soluble dietary fiber, which breads are produced by using the composition; and a method of production thereof.

1. A water-soluble dietary fiber-containing composition for bread-making, comprising a homogeneous mixture of a water-soluble dietary fiber material, and fats and oils, wherein the water-soluble dietary fiber material comprises not less than 85% by mass of a dietary fiber and the water-soluble dietary fiber-containing composition comprises 20 to 100 parts by mass of said fats and/or oils based on 100 parts by mass of said water-soluble dietary fiber material.
2. The water-soluble dietary fiber-containing composition for bread-making according to the above 1, wherein said water-soluble dietary fiber material is an indigestible dextrin.
3. The water-soluble dietary fiber-containing composition for bread-making according to the above 1 or 2, wherein the composition further comprises an emulsifier.
4. A bread fortified with a water-soluble dietary fiber, which is obtainable using as an ingredient the water-soluble dietary fiber-containing composition for bread-making according to any one of the above 1 to 3.
5. The bread fortified with a water-soluble dietary fiber according to the above 4, wherein the amount of the water-soluble dietary fiber material added to a bread dough is in the range of 4 to 16 parts by mass relative to 100 parts by mass of wheat flour.
6. A method for producing a bread fortified with a water-soluble dietary fiber, wherein the method comprises adding said water-soluble dietary fiber-containing composition for bread-making according to any one of the above 1 to 3 in a kneading step.
7. The method for producing said bread fortified with a water-soluble dietary fiber according to the above 6, wherein the addition of the water-soluble dietary fiber-containing composition for bread-making in the kneading step is a simultaneous addition with the addition of wheat flour.
8. The method for producing said bread fortified with a water-soluble dietary fiber according to the above 6 or 7, wherein the water-soluble dietary fiber-containing composition for bread-making is added so that the amount of the water-soluble dietary fiber material in the water-soluble dietary fiber composition is in the range of 4 to 16 parts by mass relative to 100 parts by mass of the wheat flour in a bread dough.

### EFFECTS OF THE INVENTION

Since the water-soluble dietary fiber-containing composition according to the present invention can be mixed simultaneously with wheat flour in preparation of bread dough, if this is used as the whole fats and oils, it is possible to simplify a preparation process of the bread dough. Also, by using the water-soluble dietary fiber-containing composition according to the present invention, bread containing the amount of the water-soluble dietary fiber enough to exert physiological effects such as prevention of elevation of blood glucose level, regulation of intestinal functions or improvement of lipid metabolism can be produced without reducing quality of the product and with ease.

### MODE FOR CARRYING OUT THE INVENTION

The water-soluble dietary fiber-containing composition according to the present invention contains a water-soluble dietary fiber material, and fats and oils.

In the present invention, the term, “water-soluble dietary fiber material” refers to indigestible saccharide containing not less than 85% by mass (in a measurement value by AOAC2001.03) of dietary fiber. The indigestible saccharide can be dissolved in water (not less than 20 g in 100 ml at 20° C.) and the viscosity of a 5% by mass aqueous solution thereof is less than 20 mPas at 20° C. Concrete examples thereof include indigestible dextrins (for example, as a commercially available product, trade name “Fibersol-2” manufactured by Matsutani Chemical Industry Co., Ltd.); polydextrose (trade name “Litesse” manufactured by Danisco Cultor); branched maltodextrins (trade name “NUTRIOSE” manufactured by Roquette); inulins or their decomposition products; guar gum decomposition products; and various oligosaccharides such as fructooligosaccharides, galactooligosaccharides and xylooligosaccharides. In addition to the above, any indigestible saccharides which meet the above-mentioned conditions of low viscosity and water solubility can be utilized. As the water-soluble dietary fiber material used in the present invention, among these water-soluble dietary fiber materials, the indigestible dextrin is most effective and preferred.

The indigestible dextrin is a dextrin with an average molecular weight of around 2000, which dextrin is obtained by decomposing starch under heat and further hydrolyzing the resultant with an enzyme, followed by decolorizing and desalting, wherein the dietary fiber content is usually not less than 85% by mass. The details are described in “Shokuhin Shinsozai Forum (Innovative Food Ingredients Forum)” No. 3 (1995, edited by Japan Confectionery and Innovative Food Ingredients Research Center).

Any kind of fats and oils can be used in the water-soluble dietary fiber-containing composition according to the present invention as long as they are edible. It is preferred to use butter, margarine, shortening, lard and the like as these fats and oils are used in usual breads.

The water-soluble dietary fiber-containing composition for bread-making according to the present invention can be prepared by mixing 0.2 parts to 1.0 part by mass, preferably 0.2 to 0.5 parts by mass, of fats and oils based on 1 part by mass of water-soluble dietary fiber material using an appropriate apparatus, for example, a desk top mixer, to make the mixture homogenous. When the ratio of fats and oils is less than 0.2 parts by mass, coating on the surface of the water-soluble dietary fiber with the fats and oils is insufficient. Consequently, when adding such composition to dough enough to exert physiological functions, the dough is poorly cohesive and the quality of bread deteriorates. Also, in cases where the ratio of fats and oils is more than 1.0 part by mass, when the amount enough to exert physiological functions was added to the dough, the fats and oils content relatively increases and therefore an appropriate fats and oils content cannot be attained. Additionally, a homogenous composition is difficult to be prepared.

In the thus prepared water-soluble dietary fiber-containing composition for bread-making according to the present invention, the water-soluble dietary fiber is coated with the fats and oils. When this composition is suspended in water, it differs from a simple mixture in that release ratio of the water-soluble dietary fiber to water is decreased. The composition according to the present invention takes the form of powder or paste depending on the type and content of the fats and oils. This can be used as a whole or as a part of the fats and oils to be blended in the bread dough.

The release ratio of the “homogenous mixture exclusively of water-soluble dietary fiber material and the fats and oils” according to the present invention to water means a value calculated from a ratio between (X) and (Y), which is represented by (X/Y)×100(%), wherein Brix concentration (water-soluble solid content concentration) (X) is determined after the homogenous mixture according to the present invention (5 g as the water-soluble dietary fiber material) is suspended in water (50 ml) at 25° C. and stirred using an SM-60N type magnetic stirrer (Masuda Seisakusho) at the number of revolutions of scale 2 for 5 minutes; and, at the same time, Brix concentration (Y) is determined after the water-soluble dietary fiber material (5 g) alone is, as a control, suspended in water and stirred under the same condition. The release ratio of the composition according to the present invention and homogenous mixture to water is preferably less than 50% by mass, further preferably less than 45% by mass.

Also, during preparation of this composition, by adding a food emulsifier(s) such as glycerol fatty acid esters, polyglycerol fatty acid esters, organic acid monoglycerides, sucrose fatty acid esters, propylene glycol fatty acid esters, sorbitan fatty acid esters, lecithins, enzymatically decomposed lecithins or calcium stearoyl lactylates, homogenization of the composition is promoted to make the composition more stable. The amount of the emulsifier to be added may be adjusted in a range where the amount is effective to make the composition homogenous; and does not adversely affect the quality of bread and the formation of dough when the emulsifier is blended in the dough. The amount of the emulsifier to be added is preferably 0.3 to 20% by mass, further preferably 5 to 15% by mass, based on the water-soluble dietary fiber material.

Further, as needed, using the emulsifier such as a fatty acid ester, an emulsified solution of the fats and oils and a water-soluble dietary fiber material can be prepared and dried by a method such as spray drying to provide powdered water-soluble dietary fiber-containing composition.

Also, antioxidant vitamins, stabilizers, wheat glutens or the like can be added as an auxiliary material.

The water-soluble dietary fiber-containing composition for bread-making according to the present invention can be added to bread dough as a whole or a part of the fats and oils used in the bread dough. The composition may be added so that the water-soluble dietary fiber material in the dough is preferably in the range of 4 to 16 parts by mass, more preferably 8 to 16 parts by mass, based on 100 parts by mass of wheat flour in the bread dough. By doing so, the water-soluble dietary fiber content contained in one serving (about 70 g) of the bread of preferably not less than 2.5 g, more preferably 5 to 7 g, is attained, and thus the amount of intake to exert physiological functions is secured.

The water-soluble dietary fiber-containing composition for bread-making according to the present invention can be kneaded (also referred to as mixing) simultaneously with the kneading of wheat flour. By adjusting the ratio between the dietary fiber and fats and oils in the composition such that a necessary amount of the water-soluble dietary fiber in a product and a necessary amount of the fats and oils to be added to the dough are both satisfied, the fats and oils and wheat flour do not need to be separately added, which enables the preparation process of the dough to be simplified.

The term “bread(s)” in the present invention refers to food product(s) produced by leavening dough obtained by mixing wheat flour, yeast, sugar, salt, fats and oils, and water, as well as the other auxiliary materials; and by baking the resulting dough. Examples thereof include Chinese-style steamed bun with pork stuffing or cyuuka manjuu, yeast doughnuts and pizzas, in addition to breads such as loaf bread, sweet pastries, baguette bread, sweet rolls, buns or rolls.

### EXAMPLES

Next, the present invention will now be concretely described below by way of examples and test examples; however the preset invention is by no means restricted thereto.

### Test Example 1

Effects of the amount of the water-soluble dietary fiber material to be added and a method of addition thereof on bread-making.

In a dough mixing process of a process for producing rectangular solid shaped loaf bread or kakushokupan by the following sponge (bread-making) method, in accordance with the formulation shown in Table 2, 4 to 16 parts by mass of indigestible dextrin (trade name: Fibersol-2, dietary fiber content: 85% by mass) based on 100 parts by mass of wheat flour was added by three different methods shown in Table 1 to examine the effects on dough formation (time lag of mixing time) and effects on quality.

Control bread-making process (sponge (bread-making) method, rectangular solid shaped loaf bread)

Sponge Mixing Low speed (3 minutes), high speed (1 minute)
Mixing temperature 24° C.
Leavening time 4 hours
   Dough Mixing Low speed (3 minutes), high speed (2 minute) (at this point, add oil or fat), low speed (2 minutes), high speed (2 minute)
Mixing temperature 28° C.
Floor time 20 minutes
Divided weight 230 g×3 pieces Bench time 20 minutes
Molding After degassing, roll the dough into a stick and mold in a “U” letter shape.
Final proof 55 minutes (38° C., 80%)
Baking 32 minutes (upper heat 195° C., lower heat 205° C.)

TABLE 1

| | Method of addition of indigestible dextrin |
|---|---|
| Control | No addition |
| Comparative | The indigestible dextrin was mixed with components |
| Example 1 | other than fats and oils and then added in dough mixing. |
| Comparative | When the fats and oils were added in dough mixing, the |
| Example 2 | indigestible dextrin was simultaneously added with the |
| | addition of fats and oils without mixing with the fats |
| | and oils. |
| Mixing | When the fats and oils were added in dough mixing, the |
| Addition | indigestible dextrin was added after it has been mixed |
| | in advance with the fats and oils by the prescribed method |

For the mixing in the mixing addition, a desk top mixer 5DM type manufactured by Shinagawa Machinery Works Co., Ltd. was used. A prescribed amount of shortening was put in a mixer bowl and stirred at low speed for about 3 minutes using a beater to loosen clumps. Thereafter, a prescribed amount of Fibersol-2 was added, stirred at low speed for about 2 minutes using a beater, followed by stirring at high speed for about 3 to 5 minutes to make the mixture homogeneous.

TABLE 2

| | | | Compar- | Compar- | |
|---|---|---|---|---|---|
| | Raw materials for | | ative | ative | Mixing |
| | bread-making | Control | Example 1 | Example 2 | addition |
| Sponge | Hard wheat flour | 70 | 70 | 70 | 70 |
| | Yeast | 2 | 2 | 2 | 2 |
| | Yeast food | 0.1 | 0.1 | 0.1 | 0.1 |
| | Water | 44 | 44 | 44 | 44 |
| Dough | Hard wheat flour | 30 | 30 | 30 | 30 |
| | Fibersol-2 | — | 4-16 | 4-16 | 4-16 |
| | Very-refined sugar | 6 | 6 | 6 | 6 |
| | Powdered skim | 2 | 2 | 2 | 2 |
| | milk | 2 | 2 | 2 | 2 |
| | Table salt | 6 | 6 | 6 | 6 |
| | Shortening | 22 | 22 | 22 | 22 |
| | Water | | | | |

(Values represent the number of grams per 100 g of flour.)

The results of evaluation carried out in accordance with the following evaluation criteria are shown in Table 3.

### Mixing Time

⊚: Similar to control
◯: Almost same or slightly lagged as compared with control
Δ: Lagged as compared with control
x: Significantly lagged as compared with control

### Outer Appearance and Interior Crumb

⊚: Similar to or slightly better than control
◯: Almost same as control
Δ: Slightly inferior to control
x: Inferior to control

### Textures

⊚: Similar to control
◯: Almost same as control
Δ: Either tackiness or roughness was seen. Slightly inferior to control.
x: Either tackiness or roughness was clearly seen. Evidently inferior to control.

From the results in Table 3, in cases where indigestible dextrin was mixed with the components other than the fats and oils(shortening) in the dough mixing and then the mixture was added (Comparative Example 1), or in cases where indigestible dextrin was simultaneously added with the fats and oils without mixing with the fats and oils when the fats and oils are added in the dough mixing (Comparative Example 2), the resulting product was evaluated as being almost similar to the control in the case where the addition was 4% by mass based on the wheat flour, whereas, in the case where the addition was not less than 10% by mass, the bread-making process and the quality of bread were found to be adversely affected depending on the added amount.

Meanwhile, in cases where indigestible dextrin was added following mixing with the fats and oils by the prescribed method when the fats and oils are added in the dough mixing (referred to as “mixing addition”), even the addition of 16% by mass was found not to substantially adversely affect the bread-making process and the quality of the thus obtained bread.

TABLE 3

| | | | Product evaluation | | |
|---|---|---|---|---|---|
| Added | Method of | Mixing | Outer | Interior | |
| amount | addition | time | appearance | crumb | Texture |
| 4% | Comparative | ◯ | ⊚ | ◯ | ◯ |
| | Example 1 | | | | |
| | Comparative | ⊚ | ⊚ | ⊚ | ⊚ |
| | Example 2 | | | | |
| | Mixing addition | ⊚ | ⊚ | ⊚ | ⊚ |
| 10% | Comparative | X | Δ | X | Δ |
| | Example 1 | | | | |
| | Comparative | X | ◯ | Δ | Δ |
| | Example 2 | | | | |
| | Mixing addition | ⊚ | ⊚ | ⊚ | ◯ |
| 12% | Comparative | X | X | X | Δ |
| | Example 1 | | | | |
| | Comparative | X | Δ | Δ | Δ |
| | Example 2 | | | | |
| | Mixing addition | ⊚ | ⊚ | ◯ | ◯ |
| 16% | Comparative | X | X | X | X |
| | Example 1 | | | | |
| | Comparative | X | Δ | X | X |
| | Example 2 | | | | |
| | Mixing addition | ◯ | ◯ | ◯ | ◯ |

### Example 1

### Preparation of a Water-Soluble Dietary Fiber-Containing Composition for Bread

Using indigestible dextrin (trade name: Fibersol-2, dietary fiber content: 85% by mass) as a water-soluble dietary fiber material, and shortening as a fat or oil, both were combined in a range of mass ratio of 1:0.2 to 1:1. For mixing, a desk top mixer 5DM type manufactured by Shinagawa Machinery Works Co., Ltd. was used. A prescribed amount of the shortening was put in a mixer bowl and stirred by a beater at low speed for about 3 minutes to loosen clumps. Thereafter, a prescribed amount of Fibersol-2 was added and the mixture was stirred by the beater at low speed for about 2 minutes followed by at high speed for 3 to 5 minutes to make the mixture homogenous. The resultants were used as compositions 1 to 5 of the present invention. After placed in a plastic bag and stored at room temperature for one day and night, the compositions 2 to 5 were applied to bread-making

TABLE 4

Mass ratio

| Composition | Fibersol-2 | Shortening |
|---|---|---|
| 1 | 1 | 1 |
| 2 | 1 | 0.5 |
| 3 | 1 | 0.33 |
| 4 | 1 | 0.25 |
| 5 | 1 | 0.2 |

The composition 2 of the present invention (7.5 g) was suspended in water (50 ml) so as to attain 10% by mass in terms of Fibersol-2 at a water temperature of 25° C. The mixture was stirred at the number of revolutions at a scale of 2 using an SM-60N type magnetic stirrer (manufactured by Masuda Seisakusho) for a prescribed amount of time. Brix concentrations (water-soluble solid content concentrations) were measured with time. At the same time, as a control, Fibersol-2 alone was suspended in water to 10% by mass and stirred under the same conditions; and then its Brix concentration was measured with time. From a ratio between them, a release ratio of Fibersol-2 was calculated. Also, as reference, Fibersol-2 (5 g) and shortening (2.5 g) were suspended in water (50 ml) and stirred under the same conditions; and then its Brix concentration was measured with time (Fibersol-2+shortening). From the results shown in Table 5, it can be seen that the release ratio of water-soluble dietary fiber in the composition according to the present invention into water is less than 50%, which is different from a simple mixture.

TABLE 5

| Stirring | Brix concentration | | | |
|---|---|---|---|---|
| time | Composition 2 | Fibersol-2 | Fibersol-2 + | Release |
| (minutes) | (X) | (Y) | shortening | ratio (%) |
| 0.5 | 2.0 | 8.5 | 9.0 | 23.5 |
| 1 | 3.5 | 8.8 | 9.0 | 39.7 |
| 2 | 4.0 | 9.0 | 9.0 | 44.4 |
| 3 | 4.0 | 9.0 | 9.0 | 44.4 |
| 4 | 4.2 | 9.0 | 9.0 | 46.6 |
| 5 | 4.2 | 9.0 | 9.0 | 46.6 |

### Example 2

### Bread-Making Test

Among the compositions obtained in Example 1, the compositions 2 to 5 were applied to bread-making A method of bread-making was same as described in Test Example 1. Formulations are shown in Table 6. When the fats and oils (shortening) were added in dough mixing, the composition was concomitantly added with the remaining fats and oils, and adjusted such that the added amount of the indigestible dextrin and fats and oils per wheat flour is 10 g and 6 g, respectively. A sample with no addition of the indigestible dextrin was used as a control. In Comparative Example, when the fats and oils were added, the indigestible dextrin and fats and oils were, without mixing, added simultaneously.

TABLE 6

| | Raw materials for | | Comparative | |
|---|---|---|---|---|
| | bread-making | Control | Example | Example |
| Sponge | Hard wheat flour | 70 | 70 | 70 |
| | Yeast | 2 | 2 | 2 |
| | Yeast food | 0.1 | 0.1 | 0.1 |
| | Water | 44 | 44 | 44 |
| Dough | Hard wheat flour | 30 | 30 | 30 |
| | Fibersol-2 | — | 10 | 10 |
| | Very-refined sugar | 6 | 6 | 6 |
| | Powdered skim milk | 2 | 2 | 2 |
| | Table salt | 2 | 2 | 2 |
| | Shortening | 6 | 6 | 6 |
| | Water | 22 | 22 | 22 |

(The values indicate the number of grams per 100 g of wheat flour.)
The results of the bread-making test evaluated in accordance with the same evaluation criteria as Test Example 1 are shown in Table 7.

TABLE 7

| | | | Product evaluation | | |
|---|---|---|---|---|---|
| | Mixing | Mixing | Outer | Interior | |
| Additives | ratio | time | appearance | crumb | Texture |
| Comparative | — | X | Δ | X | Δ |
| Example | | | | | |
| Composition 2 | 1/0.5 | ⊚ | ⊚ | ⊚ | ◯ |
| Composition 3 | 1/0.33 | ⊚ | ⊚ | ⊚ | ◯ |
| Composition 4 | 1/0.25 | ⊚ | ⊚ | ◯ | ◯ |
| Composition 5 | 1/0.2 | ◯ | ◯ | ◯ | ◯ |

From the results in Table 7, using the compositions 2 to 5 whose mixing ratio of the fats and oils to indigestible dextrin is within a range of 1:0.2 to 1:0.5, even when the indigestible dextrin was blended such that its added amount was 10 g per 100 g of wheat flour, it was confirmed that the bread-making was scarcely affected.

### Example 3

### Test for Simultaneous Kneading of Compositions and Wheat Flour

A composition with the mass ratio between indigestible dextrin and shortening of 1:0.6 was prepared in the same manner as described in Example 1. This was blended in dough so as to attain the same formulation as shown in Table 6 and mixed simultaneously with wheat flour (Example). Also, without making the composition of the indigestible dextrin and shortening, they are individually blended in the dough at the same ratio and simultaneously kneaded with wheat flour to provide Comparative Example. Table 8 shows the results of evaluation of mixing time of the thus prepared dough and the quality of bread obtained by baking the dough in accordance with the same evaluation criteria as Test Example 1.

From the results in Table 8, it was found that, when the indigestible dextrin and shortening were, without forming the composition, kneaded simultaneously with the wheat flour, the mixing and quality of bread were adversely affected. Yet, when they were, after forming the composition, kneaded simultaneously with the wheat flour, the mixing was scarcely affected and the quality of bread was not adversely affected at all. From this, it was found that the use of the composition according to the present invention enables kneading of fats and oils in the dough to be carried out at once. Thus, blending of a large quantity of the indigestible dextrin and simplification of the preparation process can be simultaneously attained.

TABLE 8

| | | | Product evaluation | | |
|---|---|---|---|---|---|
| | Method of | Mixing | Outer | Interior | |
| | addition | time | appearance | crumb | Texture |
| Comparative | Individual | X | Δ | Δ | Δ |
| Example | | | | | |
| Example | Composition | ◯ | ⊚ | ⊚ | ⊚ |

(The evaluation was carried out using a composition containing no indigestible dextrin as a control.)

### Example 4

### Preparation and Evaluation of a Composition Containing Emulsifiers

To a Fibersol-2 aqueous solution (60% by mass), Emulgy MS (Riken Vitamin Co., Ltd.) having a melting point of 68° C. was added as an emulsifier at 10% by mass based on Fibersol-2. Using TK HOMOMIXER MARKII (Tokushu Kika Kogyo Co., Ltd.) the mixture was stirred at 60° C., 8,000 rpm for 5 minutes and then dropped on a hot plate at 180° C. to be powdered. By mixing this with shortening by the method of Example 1, compositions with a mass ratio between Fibersol-2 and the fats and oils of 1:0.5 and 1:0.375 were prepared. They were used as composition 6 and 7, respectively. The composition 6 was added to wheat flour so as to attain 12% by mass in terms of Fibersol-2 and the composition 7 was added to the wheat flour so as to attain 16% by mass in terms of Fibersol-2, thereby preparing dough. With the same base formulation as in Table 2 except for Fibersol-2, the composition was simultaneously mixed with the wheat flour in the dough mixing. Comparative Examples 1 and 2 were corresponded to Comparative Examples 1 and 2 of Test Example 1. By these methods each of the dough was prepared and a bread-making test was carried out in the same manner as described in Test Example 1 for evaluation in accordance with the criteria of Test Example 1. The results are shown in Table 9.

TABLE 9

| | | | Product evaluation | | |
|---|---|---|---|---|---|
| Addition | Method of | Mixing | Outer | Interior | |
| classification | addition | time | appearance | crumb | Texture |
| 12% | Comparative | X | X | X | Δ |
| | Example 1 | | | | |
| | Comparative | X | Δ | Δ | Δ |
| | Example 2 | | | | |
| | Composition | ⊚ | ⊚ | ⊚ | ⊚ |
| 16% | Comparative | X | X | X | X |
| | Example 1 | | | | |
| | Comparative | X | Δ | X | X |
| | Example 2 | | | | |
| | Composition | ⊚ | ⊚ | ◯ | ◯ |

As compared the results in Table 9 with the results of the mixing addition (12% and 16%) shown in Table 3, it was found that a composition containing the emulsifier was evaluated more highly in the bread-making test than the composition without the emulsifier.

1. A water-soluble dietary fiber-containing composition for bread-making, comprising a homogeneous mixture of a water-soluble dietary fiber material, and fats and oils, wherein the water-soluble dietary fiber material comprises not less than 85% by mass of a dietary fiber and the water-soluble dietary fiber-containing composition comprises 20 to 100 parts by mass of said fats and/or oils based on 100 parts by mass of said water-soluble dietary fiber material.

2. The water-soluble dietary fiber-containing composition for bread-making according to claim 1, wherein said water-soluble dietary fiber material is an indigestible dextrin.

3. The water-soluble dietary fiber-containing composition for bread-making according to claim 1, wherein the composition further comprises an emulsifier.

4. A bread fortified with a water-soluble dietary fiber, which is obtainable using as an ingredient the water-soluble dietary fiber-containing composition for bread-making according to claim 1.

5. The bread fortified with a water-soluble dietary fiber according to claim 4, wherein the amount of the water-soluble dietary fiber material added to a bread dough is in the range of 4 to 16 parts by mass relative to 100 parts by mass of wheat flour.

6. A method for producing a bread fortified with a water-soluble dietary fiber, wherein the method comprises adding said water-soluble dietary fiber-containing composition for bread-making according to claim 1 in a kneading step.

7. The method for producing said bread fortified with a water-soluble dietary fiber according to claim 6, wherein the addition of the water-soluble dietary fiber-containing composition for bread-making in the kneading step is a simultaneous addition with the addition of wheat flour.

8. The method for producing said bread fortified with a water-soluble dietary fiber according to claim 6, wherein the water-soluble dietary fiber-containing composition for bread-making is added so that the amount of the water-soluble dietary fiber material in the water-soluble dietary fiber composition is in the range of 4 to 16 parts by mass relative to 100 parts by mass of the wheat flour in a bread dough.
